(19) United States
(12) Patent Application Publication
(10) Pub. No.: US 2014/0351348 A1
(43) Pub. Date: Nov. 27, 2014

(54) Method and system for sharing rich media content from mobile messaging to social media networks

(71) Applicant: Cezary Kolodziej, Deer Park, IL (US)

(72) Inventor: Cezary Kolodziej, Deer Park, IL (US)

(21) Appl. No.: 14/121,133

(22) Filed: Jun. 22, 2012

(51) Int. Cl. H04L 12/58

(52) U.S. Cl. CPC H04L 51/32; H04L 51/10
USPC 709/206

(57) ABSTRACT

The invention consists of a method and system for delivering rich media content to a mobile device via mobile messaging and then distributing that rich media content to a social media network. The invention includes an easy method for a user that receives rich media content via mobile messaging to initiate sharing the same content with other users on a social media network. The invention includes a messaging system that adapts a set of rich media content to the unique constraints of mobile messaging and to the unique constraints of specific social media networks.

### BACKGROUND OF THE INVENTION

Both mobile messaging and social media networks provide prevalent platforms for person-to-person sharing of content and for application-to-person (A2P) content. A2P content is commonly used by businesses for marketing purposes. Content delivered to users via mobile messaging can be shared to other users via mobile messaging. Similarly, users of social media networks can easily share content with other users within the context of social media networks. However, content delivered via these social networks and mobile messaging largely exist in silos without easy ways of sharing content across these platforms. Sharing across these platforms becomes even more important as mobile devices become the primary means to access social networks.

Both mobile messaging and social media platforms provide means to share content with other users via email.

### SUMMARY OF THE INVENTION

The invention consists of a method and system for delivering rich media content to a mobile device via mobile messaging and then distributing that content to a social media network. The user that receives content via mobile messaging can easily initiate the sharing of that same content with other users on a social media network.

The invention includes a messaging system that adapts a set of rich media content to the unique constraints of mobile messaging and to the unique constraints of specific social media networks.

### BRIEF DESCRIPTION OF THE DRAWINGS

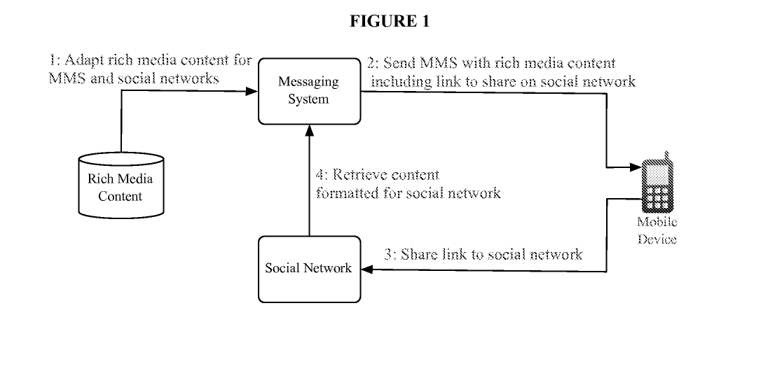

The accompanying drawing in FIG. 1 provides an overview of the environment in which the invention is defined and describes the approach used. A messaging system is shown which can adapt rich media content such that it can be delivered via MMS and via a social media network in such a way that it accommodates the unique constraints of each platform in order to produce the best possible user experience.

An MMS message is delivered to a mobile device that includes a web link that can be used to initiate sharing the same rich media content on a social media network.

### DETAILED DESCRIPTION OF THE PREFERRED EMBODIMENTS

The accompanying drawing in FIG. 1 provides an overview of the environment in which the invention is defined and describes the approach used. A messaging system is shown which can adapt rich media content such that it can be delivered via MMS. The rich media content would typically consist of a set of one or more video, audio or image content, plus accompanying text. The messaging system shown in FIG. 1 can deliver this rich media content to an MMS capable mobile device.

The text portion of the MMS message is augmented by the messaging system to include a call to action with a web link to initiate sharing the associated content with other users on one or more social media networks. When the mobile user selects the web link, their mobile web browser is directed to a mobile optimized web page that is served by the messaging system shown in FIG. 1. This web page provides a preview of the same rich media content that was delivered in the MMS message with additional links that allow the content to be shared on one or more specific social media networks. Examples of such social media networks include but are not limited to Facebook and Twitter.

When the mobile users selects a link to share content on a specific social media network, the user is directed to a specific mobile web page provided by the social media network. Typically, the social media web site would require a user to provide proper authentication information, however this step is specific to the social media network.

When content is shared to a social media network, it typically includes some preview text, possibly a preview image, and a web link that represents the full content to be displayed within the social media network. The messaging system shown in FIG. 1 provides the content displayed via this web link. The messaging system provides this content in a manner that conforms to the constraints imposed by a specific social media network.

1. A method for delivering image content to a mobile user via an MMS message that includes text with a call to action and a web link that is used to share the same content to other users on a social media network.

2. The method of claim 1, wherein the chosen content is video instead of image.

3. The method of claim 1, wherein the chosen content is audio instead of image.

4. A method for dynamically producing a mobile optimized web page with image content equivalent to the image content included in an MMS message described in claim 1.

5. A method for dynamically producing a mobile optimized web page with video content equivalent to the image content included in an MMS message described in claim 2.

6. A method for dynamically producing a mobile optimized web page with audio content equivalent to the image content included in an MMS message described in claim 3.

7. A method for sharing the image content of claim 4 with a social media network.

8. A method for sharing the video content of claim 5 with a social media network.

9. A method for sharing the audio content of claim 6 with a social media network.
